(19) United States
(12) Patent Application Publication
(10) Pub. No.: US 2023/0336503 A1
(43) Pub. Date: Oct. 19, 2023

(54) RECEIVING PACKET DATA

(71) Applicant: Microsoft Technology Licensing, LLC, Redmond, WA (US)

(72) Inventor: Shachar RAINDEL, Redmond, WA (US)

(21) Appl. No.: 17/721,771

(22) Filed: Apr. 15, 2022

(51) Int. Cl. H04L 49/90

(52) U.S. Cl. CPC H04L 49/9036; H04L 49/9084; H04L 49/9068

(57) ABSTRACT

Embodiments of the present disclosure include techniques for receiving and processing packets. A program configures a network interface to store data from each received packet in one or more packet buffers. If data from a packet exceeds the capacity of the assigned packet buffers, remaining data from the packet may be stored in an overflow buffer. The packet may then be deleted efficiently without delays resulting from handling the remaining data.

### BACKGROUND

The present disclosure relates generally to data handling in a computer system, and in particular, to receiving packet data over a network.

Computer systems are regularly connected together across networks to exchange data for a wide variety of purposes. Data is typically sent across a network in packets. In modern systems, computers may be required to process a large volume of packets at very high speeds. However, handling all this data in each computer can be time consuming and challenging. For example, all packets may not have the same amount of data. Additionally, some packets with very large data payloads may produce errors in a computer system receiving such data because the computer system may not be able to handle the large payload size. Such failures may slow down the computers performance and cause undesirable delays in data processing, for example.

Embodiments described herein advantageously eliminate delays caused by large data payloads received across a network.

### BRIEF DESCRIPTION OF THE DRAWINGS

FIG. 1 illustrates a computer system according to an embodiment.

FIG. 2 illustrates a method of processing packets according to an embodiment.

FIG. 3 illustrates a method of processing according to another embodiment.

FIG. 4 illustrates an example server computer with an overflow buffer according to an embodiment.

FIG. 5 illustrates a simplified block diagram of an example computer system used to execute program code according to various embodiments.

### DETAILED DESCRIPTION

Described herein are techniques for processing packet data. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

Features and advantages of the present disclosure include techniques for improving packet throughput speeds by employing an overflow buffer (aka a “skid” buffer) that stores data from each packet that does not fit within typical data buffers assigned to each packet as they are processed. It has been observed that data overflows can slow down packet processing in some applications. For example, when a packet arrives in a network interface, a network interface driver program may assign each packet one or more buffers (herein, “packet buffers) to store packet data. If the data in the packet is greater than a data capacity of the available packet buffers, the packet cannot be processed, and a failure occurs. However, recovering from a packet data overflow where remaining data in the packet (e.g., data that did not have room in the packet buffers) can be time consuming and slow down packet processing. It has been observed in some applications that storing the remaining data in an overflow buffer and then continuing packet processing may not incur the same time penalties as some other approaches, and may be an advantageous approach for processing packets, for example.

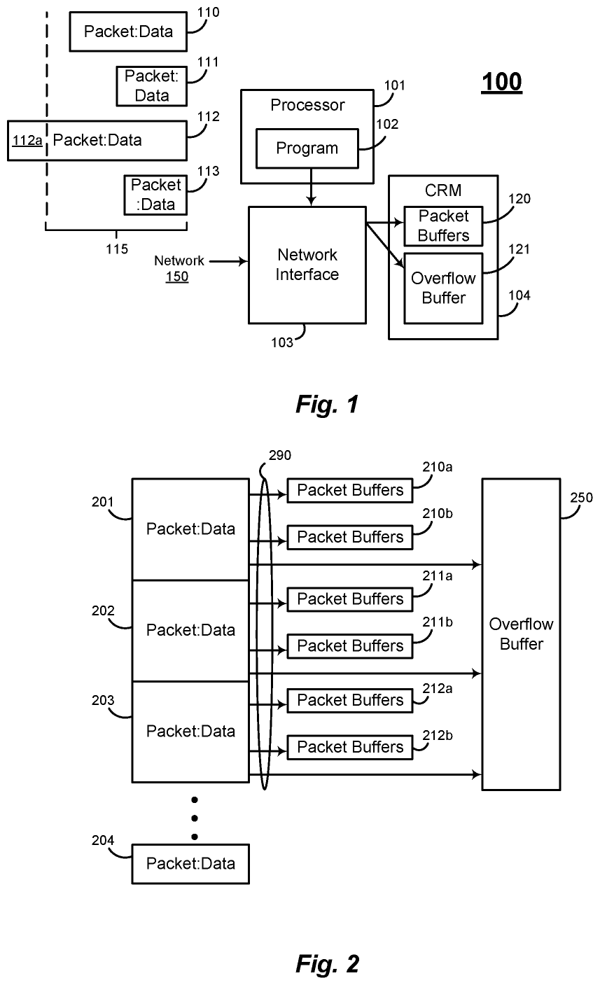

FIG. 1 illustrates a computer system 100 according to an embodiment. Computer system 100 includes a processor 101, network interface 103, and computer readable medium (CRM) 104, which may be a non-transitory CRM such as a memory circuit (e.g., random access memory). CRM 104 may store a program 102 comprising sets of instructions (program code) for controlling the network interface 103. The program 102 is executable by the processor 101 (as shown) to configure the network interface 103. Network interface 103 receives packets from a network 150. Each packet comprises data. Program 102 configures network interface 103 to store data in each packet in a corresponding packet buffer 120 stored in CRM 104. Advantageously, CRM 104 comprises an overflow buffer 121. When a size of the data in a particular packet is greater than a capacity of the corresponding packet buffer, network interface 103 stores remaining data from the particular packet in overflow buffer 121. Since the packet overflowed, program 102 may cause the particular packet to be deleted. The overflow buffer may be available for all received packets to use. Since, in some embodiments, the packets are deleted (aka dropped or discarded) if the associated packet data exceeds the packet buffer associated with each packet, each packet may use the same overflow buffer (e.g., because the data in the overflow buffer is never used).

FIG. 1 illustrates packets and corresponding data 110-113. Packets typically include headers and payloads, where the payloads store the data. A maximum capacity is shown at 115. Data associated with packets 110, 111, and 113 are all below the maximum capacity of packet buffers associated with each packet. However, data associated with packet 112 is greater than the maximum capacity of the packet buffers associated with packet 112. Accordingly, data remaining after the associated packet buffers are full (denoted 112a) is automatically stored in overflow buffer 121.

FIG. 2 illustrates a method of processing packets according to an embodiment. This figure illustrates the reception of packets 201-204. As packets are received by a network interface, a driver program configures the network interface with one or more storage locations for storing the data in each packet and the location of the overflow buffer. For example, at 290 a program may configure a network interface by sending pointers specifying storage locations (e.g., packet buffers/overflow buffer) for the data in each corresponding packet as each packet arrives. For example, data in packet 201 may be stored in packet buffers 210a and 210b using pointers, data in packet 202 may be stored in packet buffers 211a and 211b using pointers, and data in packet 203 may be stored in packet buffers 212a and 212b using pointers. Additionally, data in packets 201-203 may be stored in overflow buffer 250 using pointers if/when the size of the data in any one of packets 201-203 is greater than the capacity of the corresponding packet buffers. As illustrated in the example shown in FIG. 2, all the received packets receive a pointer to the same overflow buffer, and the overflow buffer has a capacity greater than a largest amount of data in a packet of the plurality of packets received by the network interface. Accordingly, packets in this example implementation will never fail as a result of the network interface being unable to store the received data.

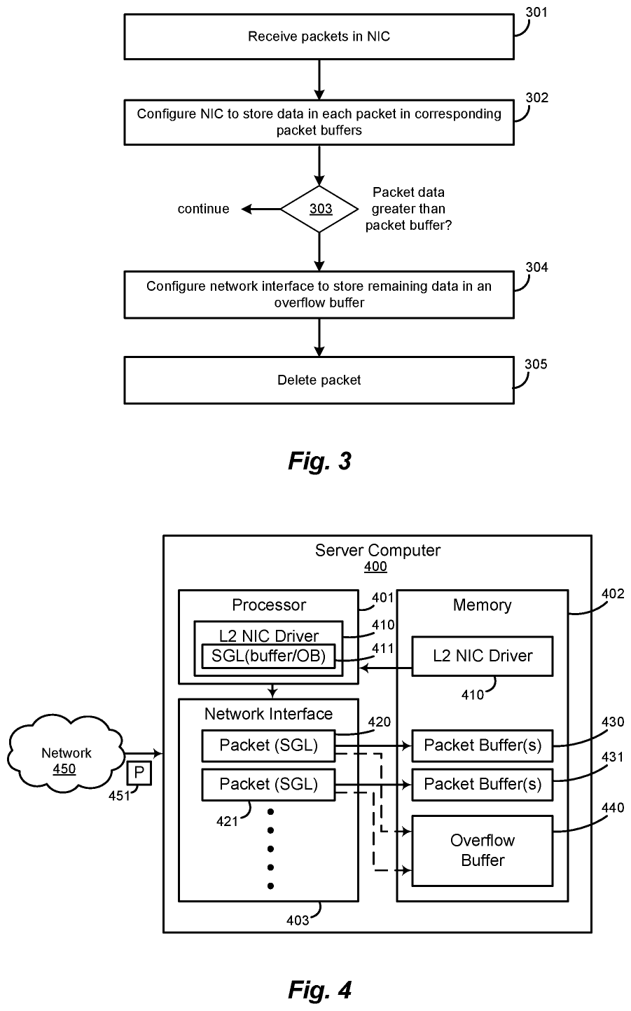

FIG. 3 illustrates a method of processing according to another embodiment. At 301, a network interface receives a plurality of packets comprising data. At 302, the network interface is configured to store data in each packet in a corresponding packet buffer. The network interface may be configured by a network interface driver program, which may configure level 2 operation of the network interface. Level 2 commonly refers to the Data Link Layer, which is the second level in the seven-layer OSI reference model for network protocol design. Layer 2 is equivalent to the link layer (the lowest layer) in the TCP/IP network model. Layer 2 is the network layer used to transfer data between adjacent network nodes in a wide area network or between nodes on the same local area network. In some example embodiments, the network interface driver sends a plurality of tuples comprising a pointer and a data length specifying storage locations (e.g., packet buffers) for the data in each corresponding packet and a pointer to an overflow buffer; for example. At 303, the flow branches based on whether the packet data is greater than the capacity of the packet buffers. If not, then more packets are processes. When a size of the data in a particular packet is greater than a capacity of the particular packet buffer, the network interface is configured to store remaining data from the particular packet in the overflow buffer. Additionally, the particular packet is deleted at 305.

FIG. 4 illustrates an example server computer with an overflow buffer according to an embodiment. In this example, a server computer system 400 may be part of a network, such as a data center, for example. Server 400 may be part of a virtual network (e.g., a VLAN), for example. Server 400 includes one or more processors 401, memory Server 400 receives packets 451 over network 450 in a network interface 403, and various forms of memory 402 (e.g., DRAM, SRAM, solid state drives, and the like denoted collectively as 402). Server 400 receives packets 451 from network 450 in network interface 403. A level 2 network interface driver program (L2 NIC Driver) 410 is loaded from memory 402 into processor 401 and executed to configure network interface 403 to receive and process packets 451. Network interface 403 may be a network interface controller (NIC), which is also refers to a network interface card, network adapter, LAN adapter or physical network interface, and by similar terms. The NIC is a computer hardware component that connects a computer to a computer network, for example.

L2 NIC Driver program 410 may configure each packet with scatter/gather lists (SGL) 411. A scatter/gather list may comprise a list of pointer/length tuples (pointer, length), which specify storage locations and available lengths in each storage location to store data from the packet, for example. SGLs may include points to packet buffers and to a shared overflow buffer. In this example, L2 NIC driver 410 configures a first packet 420 with an SGL pointing to one or more packet buffers 430 and to overflow buffer 440 for storing any remaining data that does not fit within buffer(s) 430. Likewise, L2 NIC driver 410 configures a second packet 421 with an SGL pointing to one or more packet buffers 431 and to overflow buffer 440 for storing any remaining data that does not fit within buffer(s) 431. As mentioned above, when data received with a packet does not fit within allocated packet buffers assigned by the driver 410, the remaining data is automatically and seamlessly stored in overflow buffer 440. The oversized packet may then be deleted without any delays resulting from the overflow, for example.

In one embodiment, a “pointer” in the scatter/gather list is not pointing to any actually allocated memory, but instead contains some nominal or invalid value (e.g., 0 or 0xBADCOFFE), which is never used as an actual pointer. Rather, the pointer is used as a trigger to the network interface hardware to discard this data. One potential advantage of such an implementation is that it may avoid writing the data to the host memory.

In yet another embodiment, instead of allocating an overflow buffer large enough to store the entire overflow from a packet, the network interface driver program may write an SGL as follows: {data buffer, overflow buffer, overflow buffer, overflow buffer}. This allows using a smaller overflow buffer to absorb bigger packets using a larger receive descriptor provided to the NIC for each packet. In another embodiment, an input-output memory management unit (IOMMU) may map multiple IO virtual addresses to the same overflow page, for example, and use this mapping as the overflow buffer.

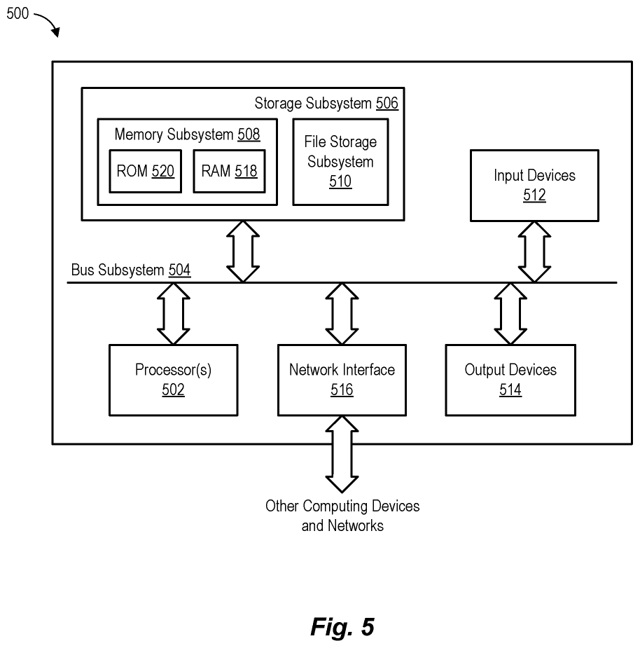

FIG. 5 illustrates a simplified block diagram of an example computer system used to execute program code according to various embodiments. In some embodiments, computer system 500 executes a program comprising sets of instructions (program code) for performing the techniques described herein. As shown in FIG. 5, computer system 500 includes one or more processors 502 that communicate with a number of peripheral devices via a bus subsystem 504. These peripheral devices may include a storage subsystem 506 (e.g., comprising a memory subsystem 508 and a file storage subsystem 510) and a network interface subsystem 516. Some computer systems may further include user interface input devices 512 and/or user interface output devices 514.

Bus subsystem 504 can provide a mechanism for letting the various components and subsystems of computer system 500 communicate with each other as intended. Although bus subsystem 504 is shown schematically as a single bus, alternative embodiments of the bus subsystem can utilize multiple busses.

Network interface subsystem 516 can serve as an interface for communicating data between computer system 500 and other computer systems or networks. Embodiments of network interface subsystem 516 can include, e.g., Ethernet, a Wi-Fi and/or cellular adapter, a modem (telephone, satellite, cable, ISDN, etc.), digital subscriber line (DSL) units, and/or the like.

Storage subsystem 506 includes a memory subsystem 508 and a file/disk storage subsystem 510. Subsystems 508 and 510 as well as other memories described herein are examples of non-transitory computer-readable storage media that can store executable program code having the functionality of embodiments of the present disclosure.

Memory subsystem 508 includes a number of memories including a main random access memory (RAM) 518 for storage of instructions and data during program execution and a read-only memory (ROM) 520 in which fixed instructions are stored. File storage subsystem 510 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 500 is illustrative and many other configurations having more or fewer components than system 500 are possible.

### FURTHER EXAMPLES

Each of the following non-limiting features in the following examples stand on their own or are combined with the other features in the examples below.

In various embodiments, the present disclosure includes computer system, method of processing packets from a network, or computer readable medium storing a program.

In one embodiment, the computer system comprises a network interface; a processor; and a non-transitory machine-readable medium storing a program executable by the processor, the program comprising sets of instructions for controlling the network interface.

In one embodiment, the network interface receives a plurality of packets comprising data.

In one embodiment, the program configures the network interface to store data in each packet in a corresponding packet buffer.

In one embodiment, when a size of the data in a particular packet is greater than a capacity of the buffer, the network interface stores remaining data from the particular packet in at least one overflow buffer, and the particular packet is deleted.

In one embodiment, for each received packet, the program configures the network interface with one or more storage locations for storing the data in each packet and at one location of the at least one overflow buffer.

In one embodiment, the program is a layer two (2) network interface driver program.

In one embodiment, the overflow buffer is a single overflow buffer having a capacity larger than a largest data packet received by the network interface.

In one embodiment, the program sends, for each received packet, a plurality of tuples comprising a pointer and a data length specifying storage locations for the data in each corresponding packet.

In one embodiment, the program further sends, for each received packet, at least one pointer to the at least one overflow buffer.

In one embodiment, the overflow buffer has a capacity large enough to prevent packet deletion due to packet size.

In one embodiment, the computer system is a server.

In one embodiment, a plurality of packets comprising data are received in a network interface.

In one embodiment, the network interface is configured to store data in each packet in a corresponding packet buffer.

In one embodiment, when a size of the data in a particular packet is greater than a capacity of the particular packet buffer, configuring the network interface to store remaining data from the particular packet in an overflow location and deleting the particular packet.

In one embodiment, for each received packet, the program configures the network interface with one or more storage locations for storing the data in each packet and one or more pointers to the overflow location.

In one embodiment, the program is a network interface driver program.

In one embodiment, the program sends, for each received packet, a plurality of tuples comprising a pointer and a data length specifying storage locations for the data in each corresponding packet.

In one embodiment, the program further sends, for each received packet, one or more pointers to the overflow location.

In one embodiment, the overflow location is an overflow buffer.

In one embodiment, the overflow buffer has a capacity larger than a largest data packet received by the network interface.

In one embodiment, the overflow buffer has a capacity large enough to prevent packet deletion due to packet size.

In one embodiment, configuring the network interface to store remaining data from the particular packet in an overflow location triggers the network interface to delete the packet without storing the remaining data.

In one embodiment, the present disclosure includes a non-transitory machine-readable medium storing a network interface driver program executable by a server.

In one embodiment, the method, system, or program perform the steps of: receiving, in a network interface, a plurality of packets comprising data; configuring the network interface to store data in each packet in a corresponding packet buffer, wherein the network interface driver program sends a plurality of tuples comprising a pointer and a data length specifying storage locations for the data in each corresponding packet and a pointer to an overflow buffer; and when a size of the data in a particular packet is greater than a capacity of the particular packet buffer, configuring the network interface to store remaining data from the particular packet in the overflow buffer and deleting the particular packet, wherein the plurality of packets receive a pointer to the same overflow buffer, and the overflow buffer has a capacity greater than a largest amount of data in a packet of the plurality of packets received by the network interface.

In one embodiment, for each received packet, the program configures the network interface with one or more storage locations for storing the data in each packet and the location of the overflow buffer.

In one embodiment, the overflow buffer has a capacity larger than a largest data packet received by the network interface.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

1. A computer system comprising:
a network interface;
a processor; and
a machine-readable medium storing a program executable by the processor, the program comprising sets of instructions for controlling the network interface, wherein the network interface receives a plurality of packets comprising data;
wherein the program configures the network interface to store data in each packet in a corresponding packet buffer, and
wherein when a size of the data in a particular packet is greater than a capacity of the corresponding packet buffer:
the network interface stores remaining data from the particular packet in at least one overflow buffer, and
the particular packet is dropped and the data for the particular packet is not used,
wherein the overflow buffer has a capacity larger than a largest data packet received by the network interface.

2. The computer system of claim 1, wherein, for each received packet, the program configures the network interface with one or more storage locations for storing the data in each packet and at one location of the at least one overflow buffer.

3. The computer system of claim 1, wherein the program is a layer two (2) network interface driver program.

4. (canceled)

5. The computer system of claim 1, wherein the program sends, for each received packet, a plurality of tuples comprising a pointer and a data length specifying storage locations for the data in each corresponding packet.

6. The computer system of claim 5, wherein the program further sends, for each received packet, at least one pointer to the at least one overflow buffer.

7. The computer system of claim 1, wherein the overflow buffer has a capacity large enough to prevent packet deletion due to packet size.

8. The computer system of claim 1, wherein the computer system is a server.

9. A method of processing packets from a network comprising:
receiving, in a network interface, a plurality of packets comprising data;
configuring the network interface to store data in each packet in a corresponding packet buffer; and
when a size of the data in a particular packet is greater than a capacity of the corresponding packet buffer:
configuring the network interface to store remaining data from the particular packet in an overflow location, and
dropping the particular packet, wherein the data for the particular packet is not used,
wherein the overflow buffer has a capacity larger than a largest data packet received by the network interface.

10. The method of claim 9, wherein, for each received packet, the program configures the network interface with one or more storage locations for storing the data in each packet and one or more pointers to the overflow location.

11. The method of claim 9, wherein the method is performed by a network interface driver program.

12. The method of claim 9, wherein the program sends, for each received packet, a plurality of tuples comprising a pointer and a data length specifying storage locations for the data in each corresponding packet.

13. The method of claim 12, wherein the program further sends, for each received packet, one or more pointers to the overflow location.

14. The method of claim 9, wherein the overflow location is an overflow buffer.

15. (canceled)

16. The method of claim 9, wherein the overflow buffer has a capacity large enough to prevent packet deletion due to packet size.

17. The method of claim 9, wherein configuring the network interface to store remaining data from the particular packet in an overflow location triggers the network interface to delete the packet without storing the remaining data.

18. A machine-readable medium storing a network interface driver program executable by a server, the program comprising sets of instructions for:
receiving, in a network interface, a plurality of packets comprising data;
configuring the network interface to store data in each packet in a corresponding packet buffer, wherein the network interface driver program sends a plurality of tuples comprising a pointer and a data length specifying storage locations for the data in each corresponding packet and a pointer to an overflow buffer; and
when a size of the data in a particular packet is greater than a capacity of the corresponding packet buffer:
configuring the network interface to store remaining data from the particular packet in the overflow buffer, and
dropping the particular packet, wherein the data for the particular packer is not used,
wherein the plurality of packets receive a pointer to the same overflow buffer, and the overflow buffer has a capacity greater than a largest amount of data in a packet of the plurality of packets received by the network interface,
wherein the overflow buffer has a capacity larger than a largest data packet received by the network interface.

19. The machine-readable medium of claim 18, wherein, for each received packet, the program configures the network interface with one or more storage locations for storing the data in each packet and the location of the overflow buffer.

20. (canceled)
